(19) United States
(12) Patent Application Publication
(10) Pub. No.: US 2015/0007031 A1
(43) Pub. Date: Jan. 1, 2015

(54) Medical Environment Simulation and Presentation System

(71) Applicant: Lucid Global, LLC., Sarasota, FL (US)

(72) Inventors: LAWRENCE KIEY, Downingtown, PA (US); DALE PARK, Poway, CA (US); RICHARD BROWNE, OLD BROOKVILLE, NY (US); JEFFREY HAZELTON, Sarasota, FL (US)

(73) Assignee: LUCID GLOBAL, LLC.

(21) Appl. No.: 13/927,822

(22) Filed: Jun. 26, 2013

(51) Int. Cl. G06F 3/0482

(52) U.S. Cl. CPC G06F 3/0482
USPC 715/723

(57) ABSTRACT

Various exemplary embodiments relate to a method and related devices including one or more of the following: displaying, on a display of the authoring device, a first representation of a environment, wherein the environment represents an anatomical structure; receiving, via a user input interface of the authoring device, a user input representing a requested change to the first representation of the environment; displaying, on the display, a transition between the first representation of the environment and a second representation, wherein the second representation is created based on the requested change; and generating a video file, wherein the video file enables playback of the transition.

### TECHNICAL FIELD

Various exemplary embodiments disclosed herein relate generally to digital presentations.

### BACKGROUND

Medical environments may be used to help describe or communicate information such as chemical, biological, and physiological structures, phenomena, and events. Until recently, traditional medical environments have consisted of drawings or polymer-based physical structures. However, because such models are static, the extent of description or communication that they may facilitate is limited. While some drawing models may include multiple panes and while some physical models may include colored or removable components, these models are poorly suited for describing or communicating dynamic chemical, biological, and physiological structures or processes. For example, such models poorly describe or communicate events that occur across multiple levels of organization, such as one or more of atomic, molecular, macromolecular, cellular, tissue, organ, and organism levels of organization, or across multiple structures in a level of organization, such as multiple macromolecules in a cell.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by an authoring device for creating a digital medical presentation, the method including: displaying, on a display of the authoring device, a first representation of a environment, wherein the environment represents an anatomical structure; receiving, via a user input interface of the authoring device, a user input representing a requested change to the first representation of the environment; displaying, on the display, a transition between the first representation of the environment and a second representation, wherein the second representation is created based on the requested change; and generating a video file, wherein the video file enables playback of the transition.

Various embodiments described herein relate to a device for creating a digital medical presentation, the authoring device including: a display device configured to display image data to a user; a user input interface configured to receive input from a user; a memory configured to store a environment that represents an anatomical structure; and at least one processor configured to: cause the display device to display a first representation of the environment, receive, via the user input interface, a user input representing a requested change to the first representation of the environment; cause the display device to display a transition between the first representation of the environment and a second representation, wherein the second representation is created based on the requested change; and generate a video file, wherein the video file enables playback of the transition.

Various embodiments described herein relate to a non-transitory machine-readable storage medium encoded with instructions for execution by an authoring device for creating a digital medical presentation, the medium including: instructions for displaying, on a display of the authoring device, a first representation of a environment, wherein the environment represents an anatomical structure; instructions for receiving, via a user input interface of the authoring device, a user input representing a requested change to the first representation of the environment; instructions for displaying, on the display, a transition between the first representation of the environment and a second representation, wherein the second representation is created based on the requested change; and instructions for generating a video file, wherein the video file enables playback of the transition.

Various embodiments described herein relate to a non-transitory machine-readable storage medium encoded with instructions for execution by an authoring device for creating a digital medical presentation, the medium including: instructions for simulating an anatomical structure and a biological event associated with the anatomical structure, wherein the biological event comprises at least one of a biological function, a malady, a drug administration, a surgical device implantation, and a surgical procedure; instructions for enabling user interaction via a user interface device to alter the simulation of the anatomical structure and the biological event; instructions for displaying a graphical representation of the anatomical structure and the biological event via a display device to a user, wherein display of the graphical representation based on the simulation and user interaction creates a user experience; and instructions for creating a video file, wherein the video file enables playback of the user experience.

Various embodiments are described wherein the first representation and the second representation are created from the point of view of a camera having at least one of a position, a zoom, and an orientation, and the requested change includes a request to alter at least one of the position, the zoom, and the orientation of the camera.

Various embodiments are described wherein the requested change includes a request to trigger a biological event associated with the anatomical structure, and the transition includes a plurality of image frames that simulate the biological event with respect to the environment.

Various embodiments are described wherein the requested change includes a request to view another anatomical structure, and the second representation is created based on another environment that represents the other anatomical structure.

Various embodiments additionally include receiving a user input representing a requested edit from a user; and modifying the video file based on the requested edit.

Various embodiments are described wherein the requested edit includes a request to add audio data to the video file, and modifying the video file includes adding the audio data to an audio track of the video file, whereby the video file enables playback of the audio data contemporaneously with the transition.

Various embodiments are described wherein the requested edit includes a request to add an activatable element to the video file, and modifying the video file includes: adding a graphic to a first portion of the video file, and associating the graphic with a second portion of the video file, whereby a user selection of the graphic during playback of the first portion of the video file initiates playback of the second portion of the video file.

Various embodiments additionally include publishing the video file for playback on at least one viewing device other than the authoring device.

The subject matter described herein may be useful in various industries, including the medical- and science-based industries, as a new platform for communicating biological concepts and phenomena. In one aspect, the present invention features an immersive virtual medical environment. Medical environments allow for the display of real-time, computer-generated medical environments in which a user may view a virtual environment of a biological structure or a biological event, such as a beating heart, an operating kidney, a physiologic response, or a drug effect, all within a high-resolution virtual space. Unlike traditional medical simulations, medical environments allow a user to actively navigate and explore the biological structure or biological event and thereby select or determine an output in real time. Accordingly, medical environments provide a powerful tool for users to communicate and understand any aspect of science.

Various embodiments allow user to record and save their navigation and exploration choices so that user-defined output may be displayed to or exported to other users. Optionally, the user may include user-defined audio voice-over, captions, or highlighting with the user-defined output. In certain embodiments, the system may include a custom virtual environment programmed to medically-accurate specifications.

In another aspect, the invention may include an integrated system that includes a library of environments and that is designed to allow a user to communicate dynamic aspects of various biological structures or processes. Users may include, for example, physicians, clinicians, researchers, professors, students, sales representatives, educational institutions, research institutions, companies, television programs, news outlets, and any party interested in communicating a biological concept.

Medical simulation provides users with a first-person interactive experience within a dynamic computer environment. The environment may be rendered by a graphics software engine that produces images in real time and is responsive to user actions. In certain embodiments, medical environments allow users to make and execute navigation commands within the environment and to record the output of the user's navigation. The user-defined output may be displayed or exported to another party, for example, as a user-defined medical animation. In some embodiments, a user may begin by launching a core environment. Then, the user may view and navigate the environment. The navigation may include, for example, one or more of (a) directionally navigating from one virtual object to a second virtual object in the medical environment; (b) navigating about the surface of a virtual object in the virtual medical environment; (c) navigating from inside to outside (or from outside to inside) a virtual object in the virtual medical environment; (d) navigating from an aspect at one level of organization to an aspect at second level of organization of a virtual object in the virtual medical environment; (e) navigating to a still image in a virtual medical environment; (f) navigating acceleration or deceleration of the viewing speed in a virtual medical environment; and (g) navigation specific to a particular environment. In addition, the user may add, in real-time or later in a recording session, one or more of audio voice-over, captions, and highlighting. The user may record his or her navigation output and optional voice-over, caption, or highlight input. Then, the user may select to display his or her recorded output or export his or her recorded output.

In certain embodiments, the system is or includes software that delivers real-time medical environments to serve as an interactive teaching and learning tool. The tool is specifically useful to aid in the visualization and communication of dynamic concepts in biology or medical science. Users may create user-defined output, as described above, for educating or communicating to oneself or another, such as a patient, student, peer, customer, employee, or any audience. For example, a user-defined output from a medical simulation may be associated with a patient file to remind the physician or to communicate or memorialize for other physicians or clinicians the patient's condition. A environment or a user-defined output from a medical simulation may be used when a physician explains a patient's medical diagnosis to the patient. A medical simulation or user-defined output from a medical simulation may be used as part of a presentation or lecture to patients, students, peers, colleagues, customers, viewers, or any audience.

Medical simulations may be provided as a single product or an integrated platform designed to support a growing library of individual virtual medical environments. As a single product, medical simulations may be described as a virtual medical environment in which the end-user initially interacts with a distinct biological structure, such as a human organ, or a biological event, such as a physiologic function, to visualize and navigate various aspects of the structure or event. A medical simulation may provide a first-person, interactive and computerized environment in which users possess navigation control for viewing and interacting with a functional model of a biological structure, such as an organ, tissue, or macromolecule, or a biological event. Accordingly, in certain embodiments, medical simulations are provided as part of an individual software program that operates with a user's computer to display on a graphical interface a virtual medical environment and allows the user to navigate the environment, to record the navigation output (e.g., as a medical animation), and, optionally, to add user-defined input to the recording and, thus, to the user-defined output.

The medical simulation software may be delivered to a computer via any method known in the art, for example, by Internet download or by delivery via any recordable medium such as, for example, a compact disk, digital disk, or flash drive device. In certain embodiments, the medical simulation software program may be run independent of third party software or independent of internet connectivity. In certain embodiments, the medical simulation software may be compatible with third party software, for example, with a Windows operating system, Apple operating system, CAD software, an electronic medical records system, or various video game consoles (e.g., the Microsoft Xbox or Sony Playstation). In certain embodiments, medical simulations may be provided by an “app” or application on a cell phone, smart phone, PDA, tablet, or other handheld or mobile computer device. In certain embodiments, the medical simulation software may be inoperable or partially operable in the absence of internet connectivity.

As an integrated product platform, medical simulations may be provided through a library of medical environments and may incorporate internet connectivity to facilitate user-user or user-service provider communication. For example, in certain embodiments, a first virtual medical environment may allow a user to launch a Supplement to the first medical environment or it may allow the user to launch a second medical environment regarding a related or unrelated biological structure or event, or it may allow a user to access additional material, information, or links to web pages and service providers. Updates to environments may occur automatically and users may be presented with opportunities to participate in sponsored programs, product information, and promotions. In this sense, medical simulation software may include a portal for permission marketing.

From the perspective of the user, medical environments may be the driving force behind the medical simulations platform. A environment may correspond to any one or more biological structures or biological events. For example, a environment may include one or more specific structures, such as one or more atoms, molecules, macromolecules, cells, tissues, organs, and organisms, or one or more biological events or processes. Examples of environments include a virtual environment of a functioning human heart; a virtual environment of a functioning human kidney; a virtual environment of a functioning human joint; a virtual environment of an active neuron or a neuronal net; a virtual environment of a seeing eyeball; and a virtual environment of a growing solid tumor.

In certain embodiments, each environment of a biological structure or biological event may serve as a core environment and provide basic functionality for the specific subject of the environment. For example, with the heart environment, users may freely navigate around a beating heart and view it from any angle. The user may choose to record his or her selected input and save it to a non-transitory computer-readable medium and or export it for later viewing.

As mentioned above, medical simulations allow user to navigate a virtual medical environment, record the navigation output, and, optionally, add additional input such as voice-over, captions, or highlighting to the output. Navigation of the virtual medical environment by the user may be performed by any method known in the art for manipulating an image on any computer screen, including PDA and cell phone screens. For example, navigation may be activated using one or more of: (a) a keyboard, for example, to type word commands or to keystroke single commands; (b) activatable buttons displayed on the screen and activated via touchscreen or mouse; (c) a multifunctional navigation tool displayed on the screen and having various portions or aspects activatable via touchscreen or mouse; (d) a toolbar or command center displayed on the screen that includes activatable buttons, portions, or text boxes activated by touchscreen or mouse, and (e) a portion of the virtual environment that itself is activatable or that, when the screen is touched or the mouse cursor is applied to it, may produce a window with activatable buttons, optionally activated by a second touch or mouse click.

The navigation tools may include any combination of activatable buttons, object portions, keyboard commands, or other features that allow a user to execute corresponding navigation commands. The navigation tools available to a user may include, for example, one or more tools for: (a) directionally navigating from one virtual object to a second virtual object in the medical environment; (b) navigating about the surface of a virtual object in the virtual medical environment; (c) navigating from inside to outside (or from outside to inside) a virtual object in the virtual medical environment; (d) navigating from an aspect at one level of organization to an aspect at second level of organization of a virtual object in the virtual medical environment; (e) navigating to a still image in a virtual medical environment; (f) navigating acceleration or deceleration of the viewing speed in a virtual medical environment; and (g) executing navigation commands that are specific to a particular environment. Additional navigation commands and corresponding tools available for a environment may include, for example, a command and tool with the heart environment to make the heart translucent to better view blood movement through the chambers.

In addition, the navigation tools may include one or more tools to activate one or more of: (a) recording output associated with a user's navigation decisions; (b) supplying audio voiceover to the user output; (c) supplying captions to the user output; (d) supplying highlighting to the user output; (e) displaying the user's recorded output; and (f) exporting the user's recorded output.

In certain embodiments, virtual medical environments are but one component of an integrated system. For example, a system may include a library of environments. In addition, various components of a system may include one or more of the following components: (a) medical environments; (b) control panel or “viewer;” (c) Supplements; and (d) one or more databases. The virtual medical environment components have been described above as individual environments. The viewer component, the Supplements component, and the database component are described in more detail below.

Users may access one or more environments from among a plurality of environments. For example, a particular physician may wish to acquire one or both of the Heart environment and the Liver environment. In certain embodiments, users may obtain a full library of environments. In certain embodiments, a viewer may be included as a central utility tool that allows users to organize and manage their environments, as well as manage their interactions with other users, download updates, or access other content.

From a user's perspective, the viewer may be an organization center and it may be the place where users launch their individual environments. In the background, the viewer may do much more. For example, back-end database management known in the art may be used to support the various services and two-way communication that may be implemented via the viewer. For example, as an application, the viewer may perform one or more of the following functions: (a) launch one or more environments or Supplements; (b) organize any number of environments or Supplements; (c) detect and use an internet connection, optionally automatically; (e) contain a Message Center for communications to and from the user; (f) download (acquire) new environments or content; (g) update existing environments, optionally automatically when internet connectivity is detected; and (h) provide access to other content, such as web pages and internet links, for example, Medline or journal article web links, or databases such as patient record databases.

The viewer may include discrete sections to host various functions. For example the viewer may include a Launch Center for organization and maintenance of the library for each user. Environments that users elect to install may be housed and organized in the Launch Center. Each environment may be represented by an icon and title (e.g., Heart).

The viewer may include a Control Center. The Control center may include controls that allow the user to perform actions, such as, for example, one or more of registration, setting user settings, contacting a service provider, linking to a web site, linking to an download library, navigating a environment, recording a navigation session, and supplying additional input to the user's recorded navigation output. In certain embodiments, the actions that are available to the user may be set to be status dependent.

The viewer may include a Message Center having a message window for users to receive notifications, invitations, or announcements from service providers. Some messages may be simple notifications and some may have the capability to launch specific activities if accepted by the user. As such, the Message Center may include an interactive feedback capability. Messages pushed to the Message Center may have the capability to launch activities such as linking to external web sites (e.g., opening in a new window) or initiating a download. The Message Center also may allow users to craft their own messages to a service provider.

As described, core environments may provide basic functionality for a specific medical structure. In certain embodiments, this functionality may be extended into a specialized application, or Supplement, which is a module that may be added to one or more core environments. Just as there are a large number of core environments that may be created, the number of potential Supplements that may be created is many fold greater, since each environment may support its own library of Supplements. Additional Supplements may include, for example, viewing methotrexate therapy, induction of glomerular sclerosis, or a simulated myocardial infarction, within the core environment. Supplements may act as custom-designed plug-in modules and may focus on a specific topic, for example, mechanism of action or disease etiology. Tools for activating a Supplement may be the same as any of the navigation tools described above. For example, a Neoplasm core environment may be associated with three Supplements that may be activated via an activatable feature of the environment.

In certain embodiments, the system is centralized around a viewer or other application that may reside on the user's computer or mobile device and that may provide a single window where the activities of each user are organized. In the background, the viewer may detect an Internet connection and may establish a communication link between the user's computer and a server.

On the server, a secure database application may monitor and track information retrieved from relative applications of all users. Most of the communications may occur in the background and may be transparent to the user. The communication link may be “permission based,” meaning that the user may have the ability to deny access.

The database application may manage all activities relating to communications between the server and the universe of users. It may allow the server to push selected information out to all users or to a select group of users. It also may manage the pull of information from all users or from a select group of users. The “push/pull” communication link between users and a central server allows for a host of communications between the server and one or more users.

### BRIEF DESCRIPTION OF THE DRAWINGS

In order to better understand various exemplary embodiments, reference is made to the accompanying drawings, wherein:

FIG. 1 illustrates an exemplary system for creating and viewing presentations;

FIG. 2 illustrates an exemplary process flow for creating and viewing presentations;

FIG. 3 illustrates an exemplary hardware device for creating or viewing presentations;

FIG. 4 illustrates an exemplary arrangement of environments and supplements for use in creating presentations;

FIG. 5 illustrates an exemplary method for recording user interaction with environments and supplements;

FIG. 6 illustrates an exemplary graphical user interface for providing access to a library of environments and supplements;

FIG. 7 illustrates an exemplary graphical user interface for recording interaction with environments and supplements;

FIG. 8 illustrates an exemplary method for toggling recording mode for environments and supplements;

FIG. 9 illustrates an exemplary method for outputting image data to a video file;

FIG. 10 illustrates an exemplary graphical user interface for editing a video file;

FIG. 11 and FIG. 12 illustrate an exemplary method for editing a video file;

FIG. 13 illustrates an exemplary graphical user interface for playing back a video file; and

FIG. 14 illustrates an exemplary method for playing back a video file.

### DETAILED DESCRIPTION

Referring now to the drawings, in which like numerals refer to like components or steps, there are disclosed broad aspects of various exemplary embodiments. The term, “or,” as used herein, refers to a non-exclusive or (i.e., and/or), unless otherwise indicated (e.g., “or else” or “or in the alternative”). It will be understood that the various embodiments described herein are not necessarily mutually exclusive, as some embodiments may be combined with one or more other embodiments to form new embodiments.

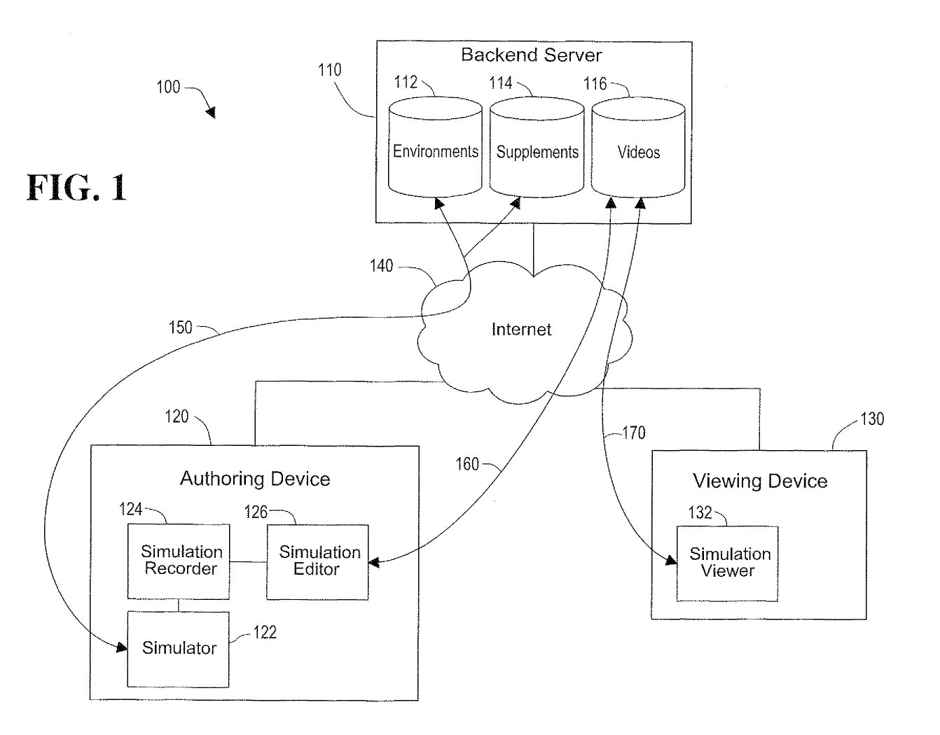

FIG. 1 illustrates an exemplary system 100 for creating and viewing presentations. The system may include multiple devices such as a backend server 110, an authoring device 120, or a viewing device 130 in communication via a network such as the Internet 140. It will be understood that various embodiments may include more or fewer of a particular type of device. For example, some embodiments may not include a backend server 110 and may include multiple viewing devices.

The backend server 110 may be any device capable of providing information to one or more authoring devices 120 or viewing devices 130. As such, the backend server 110 may include, for example, a personal computer, laptop, server, blade, cloud device, tablet, or set top box. Various additional hardware devices for implementing the backend server 110 will be apparent. The backend server 110 may also include one or more storage devices 112, 114, 116 for storing data to be served to other devices. Thus, the storage devices 112, 114, 116 may include a machine-readable storage medium such as read-only memory (ROM), random-access memory (RAM), magnetic disk storage media, optical storage media, flash-memory devices, or similar storage media. The storage devices 112, 114, 116 may store information such as environments and supplements for use by the authoring device 120 and videos for use by the viewing device 130.

The authoring device 120 may be any device capable of creating and editing presentation videos. As such, the authoring device 120 may include, for example, a personal computer, laptop, server, blade, cloud device, tablet, or set top box. Various additional hardware devices for implementing the authoring device 120 will be apparent. The authoring device 120 may include multiple modules such as a simulator 122 configured to simulate anatomical structures and biological events, a simulation recorded 124 configured to create a video file based on the output of the simulator 122, and a simulation editor 126 configured to enable a user to edit video created by the simulation recorded 124.

The viewing device 130 may be any device capable of viewing presentation videos. As such, the viewing device 130 may include, for example, a personal computer, laptop, server, blade, cloud device, tablet, or set top box. Various additional hardware devices for implementing the viewing device 130 will be apparent. The viewing device 120 may include multiple modules such as a simulation viewer 132 configured to playback a video created by an authoring device 120. It will be apparent that this division of functionality may be different according to other embodiments. For example, in some embodiments, the viewing device 130 may alternatively or additionally include a simulation editor 126 or the authoring device 120 may include a simulation viewer 132.

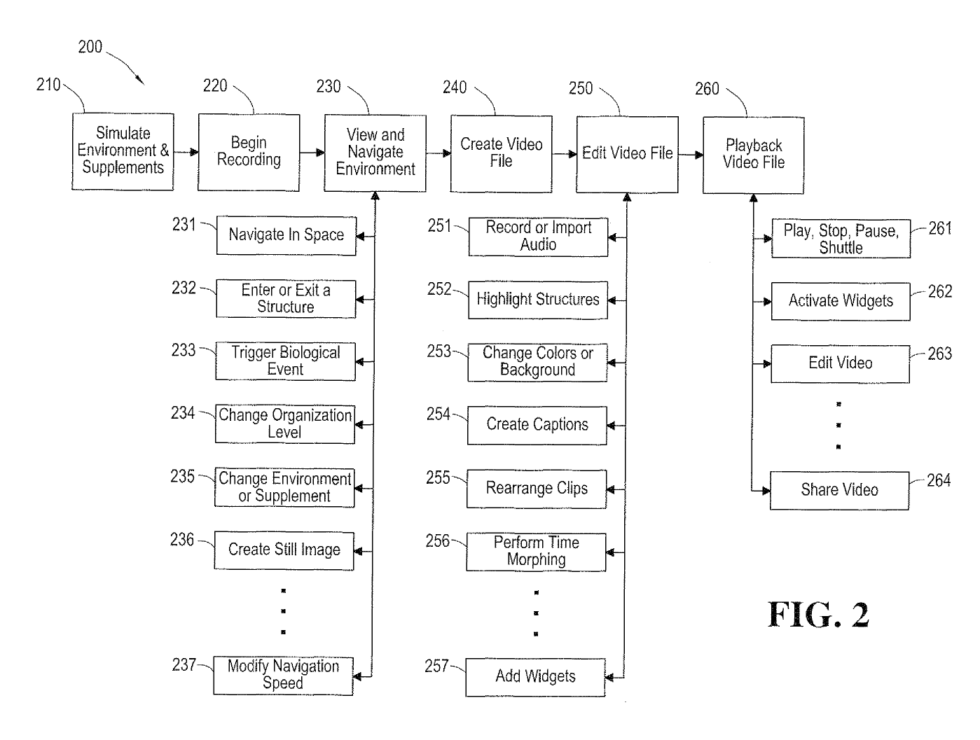

Having described the components of the exemplary system 100, a brief summary of the operation of the system 100 will be provided. It should be apparent that the following description is intended to provide an overview of the operation of system 100 and is therefore a simplification in some respects. The detailed operation of the system 100 will be described in further detail below in connection with FIGS. 2-15.

According to various exemplary embodiments, a user of the authoring device 120 may begin by selecting one or more environments and supplements stored on the backend server 110 to be used by the simulator 122 for simulating an anatomical structure or biological event. For example, the user may select a environment of a human heart and a supplement for simulating a malady such as, for example, a heart attack. After this selection, the backend server 110 may deliver 150 the data objects to the authoring device 120. The simulator 122 may load the data objects and begin the requested simulation. While simulating the anatomical structure or biological event, the simulator 122 may provide the user with the ability to modify the simulation by, for example, navigating in three dimensional space or activating biological events. The user may also specify that the simulation should be recorded via a user interface. After such specification, the simulation recorder 124 may capture image frames from the simulator 122 and create a video file. After the user has indicated that recording should cease, the simulation editor 126 may receive the video file from the simulation recorder 124. Then, using the simulation editor 126, the user may edit the video by, for example, rearranging clips or adding audio narration. After the user has finished editing the video, the authoring device 120 may upload 160 the video to be stored at the backend server 110. Thereafter, the viewing device 130 may download or stream 170 the video from the backend server for playback by the simulation viewer 132. As such, the viewing device may be able to replay the experience of the authoring device 120 user when originally interacting with the simulator 122.

It will be apparent that various other methods of distributing environments, supplements, or videos may be utilized. For example, in some embodiments, environments, supplements, or videos may be available for download from a third party provider, other than any party operating the exemplary system 100 or portion thereof. In other embodiments, environments, supplements, or videos may be distributed using a physical medium such as a DVD or flash memory device. Various other channels for data distribution will be apparent.

FIG. 2 illustrates an exemplary process flow 200 for creating and viewing presentations. As shown, the process flow may being in step 210 where an environment and one or more supplements are used to create an interactive simulation of an anatomical structure or biological event. In step 220, the user may specify that the simulation should be recorded. The user may then, in step 230, view and navigate the simulation. These interactions may be recorded to create a video for later playback. For example, the user may navigate in space 231, enter or exit a structure 232 (e.g., enter a chamber of a heart), trigger a biological event 233 (e.g., a heart attack or drug administration), change a currently viewed organization level 234 (e.g., from organ-level to cellular level), change a environment or supplement 235 (e.g., switch from viewing a heart environment to a blood vessel environment), create a still image 236 of a current view, or modify a speed of navigation 237.

After the user has captured the desired simulation, the system may, in step 240, create a video file which may then be edited in step 250. For example, the user may record or import audio 251 to the video (e.g., audio narration), highlight structures 252 (e.g., change color of the aorta on the heart environment), change colors or background 253, create textual captions 254, rearrange clips 255, perform time morphing 256 (e.g., speed up or slow down playback of a specific clip), or add widgets 257 which enable a user viewing the video to activate a button or other object to affect playback by, for example, showing a nested video within the video file. After the user has finished editing the video, the video may be played back in step 260 to the user or another entity using a different device. In some embodiments, the user may be able to skip the editing step 250 entirely and proceed directly from the end of recording at step 240 to playback at step 260.

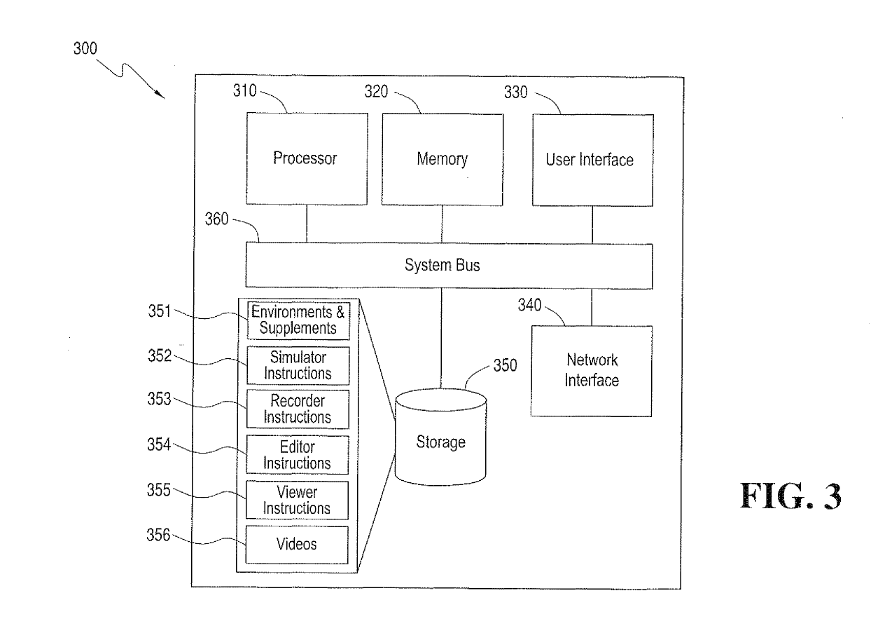

FIG. 3 illustrates an exemplary hardware device 300 for creating or viewing presentations. As such, the hardware device may correspond to the backend server 110, authoring device 120, or playback device 130 of the exemplary system. As shown, the hardware device 300 may include a processor 310, memory 320, user interface 330, network interface 340, and storage 350 interconnected via one or more system buses 360. It will be understood that FIG. 3 constitutes, in some respects, and abstraction and that the actual organization of the components of the hardware device 300 may be more complex than illustrated.

The processor 310 may be any hardware device capable of executing instructions stored in memory 320 or storage 350. As such, the processor may include a microprocessor, field programmable gate array (FPGA), application-specific integrated circuit (ASIC), or other similar devices.

The memory 320 may include various memories such as, for example L1, L2, or L3 cache or system memory. As such, the memory 320 may include static random access memory (SRAM), dynamic RAM (DRAM), flash memory, read only memory (ROM), or other similar memory devices.

The user interface 330 may include one or more devices for enabling communication with a user. For example, the user interface 330 may include a display and speakers for displaying video and audio to a user. As further examples, the user interface 330 may include a mouse and keyboard for receiving user commands and a microphone for receiving audio from the user.

The network interface 340 may include one or more devices for enabling communication with other hardware devices. For example, the network interface 340 may include a network interface card (NIC) configured to communicate according to the Ethernet protocol. Additionally, the network interface 240 may implement a TCP/IP stack for communication according to the TCP/IP protocols. Various alternative or additional hardware or configurations for the network interface 240 will be apparent.

The storage 350 may include one or more machine-readable storage media such as read-only memory (ROM), random-access memory (RAM), magnetic disk storage media, optical storage media, flash-memory devices, or similar storage media. In various embodiments, the storage 350 may store instructions for execution by the processor 310 or data upon with the processor 310 may operate. For example, the storage 350 may store various environments and supplements 351, simulator instructions 352, recorder instructions 353, editor instructions 354, viewer instructions 355, or videos 356. It will be apparent that the storage 350 may not store all items in this list and that the items actually stored may depend on the role taken by the hardware device. For example, where the hardware device 300 constitutes a viewing device 130, the storage 350 may not store any environments and supplements 351, simulator instructions 352, or recorder instructions 353. Various additional items and other combinations of items for storage will be apparent.

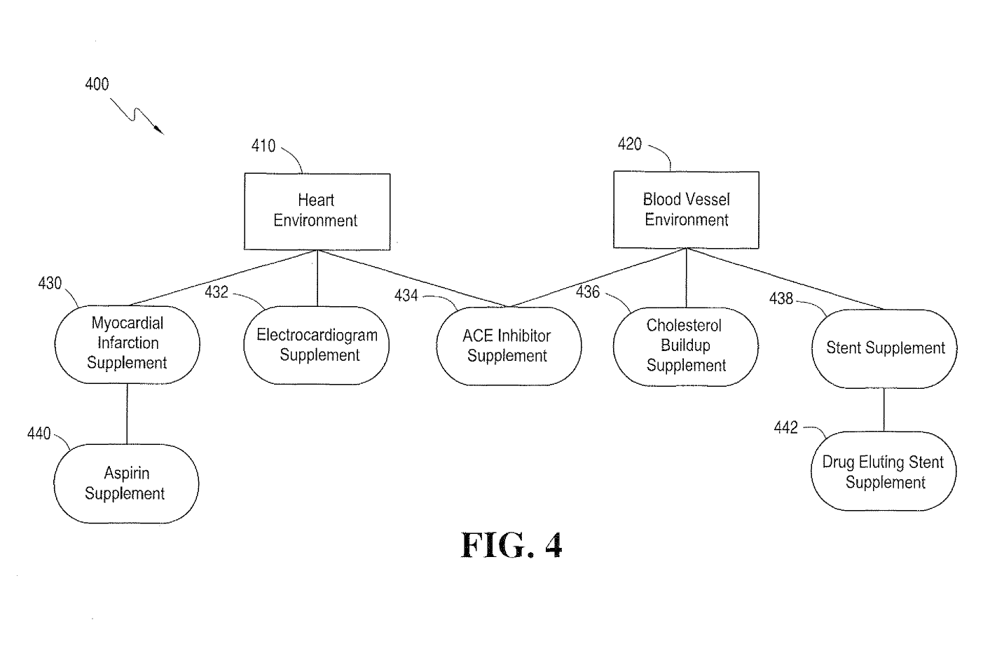

FIG. 4 illustrates an exemplary arrangement 400 of environments and supplements for use in creating presentations. As explained above, various systems, such as an authoring system 120 or, in come embodiments, a viewing device 130, may use environments or supplements to simulate anatomical structures or biological events. Environments may be objects that define basic functionality of an anatomical structure. As such, a environment may define a three-dimensional model for the structure, textures or coloring for the various surfaces of the three-dimensional model, and animations for the three-dimensional model. Additionally, a environment may define various functionality associated with the structure. For example, a heart environment may define functionality for simulating a biological function such as a heart beat or a blood vessel environment may define functionality for simulating a biological function such as blood flow. In various embodiments, environments may be implemented as classes or other data structures that include data sufficient for defining the shape and look of an anatomical structure and functions sufficient to simulate biological events and update the shape and look of the anatomical structure accordingly. In some such embodiments, the environments may implement “update” and “draw” methods to be invoked by methods of a game or other rendering engine.

Supplements may be objects that extend functionality of environments or other supplements. For example, supplements may extend a heart environment to simulate a heart attack or may extend a blood vessel environment to simulate the implantation of a stent. In various embodiments, supplements may be classes or other data structures that extend or otherwise inherit from other objects, such as environments or other supplements, and define additional functions that simulate additional biological events and update the shape and look of an anatomical structure (as defined by an underlying object or by the supplement itself) accordingly. In some embodiments, a supplement may carry additional three-dimensional models for rendering additional items such as, for example, a surgical device or a tumor. In some such embodiments, a supplement may implement “update” and “draw” methods to be invoked by methods of a game or other rendering engine. In some cases, the update and draw methods may override and themselves invoke similar methods implemented by underlying objects.

Exemplary arrangement 400 includes two exemplary environments: a heart environment 410 and a blood vessel environment 420. The heart environment 410 may be an object that carries a three-dimensional model of a heart and instructions sufficient to render the three-dimensional model and to simulate some biological functions. For example, the instructions may simulate a heart beat. Likewise, the blood vessel environment 420 may be an object that carries a three-dimensional model of a blood vessel and instructions sufficient to render the three-dimensional model and to simulate some biological functions. For example, the instructions may simulate blood flow. As described above, the heart environment 410 and blood vessel environment 420 may be implemented as classes or other data structures which may, in turn, extend or otherwise inherit from a base environment class.

The arrangement 400 may also include multiple supplements 430-442. The supplements 430-442 may be objects, such as classes or other data structures, that define additional functionality in relation to an underlying model 410, 420. For example, a myocardial infarction supplement 430 and an electrocardiogram supplement 432 may both extend the functionality of the heart environment 410. The myocardial infarction supplement 430 may include instructions for simulating a heart attack on the three dimensional model defined by the heart environment 410. The myocardial infarction supplement 430 may also include instructions for displaying a button or otherwise receiving user input toggling the heart attack simulation. The electrocardiogram (EKG) supplement 432 may include instructions for simulating an EKG device. For example, the instructions may display a graphic of an EKG monitor next to the three dimensional model of the heart. The instructions may also display an EKG output based on simulated electrical activity in the heart. For example, as part of the simulation of a heart beat or heart attack, the heart environment 410 or myocardial infarction supplement 430 may generate simulated electrical currents which may be read by the EKG supplement 432. Alternative methods for simulating an EKG readout will be apparent.

Some supplements may extend the functionality of multiple environments. For example, the ACE inhibitor supplement 434 may include extended functionality for both the heart environment 410 and the blood vessel environment 420 to simulate the effects of administering an ACE inhibitor medication. In some embodiments, the ACE inhibitor supplement 410 may actually extend or otherwise inherit from an underlying base environment class from which the heart environment 410 and blood vessel 420 may inherit. Further, the ACE inhibitor supplement 434 may define separate functionality for the different environments 410, 420 from which it may inherit or may implement the same functionality for use by both environments 410, 420, by relying on commonalities of implementation. For example, in embodiments wherein both the heart environment 410 and blood vessel environment 420 are implemented to simulate biological events based on a measure of angiotensin-converting-enzyme or blood vessel dilation, activation of the ACE inhibitor functionality may reduce such a measure, thereby affecting the simulation of the biological event.

As further examples, a cholesterol buildup supplement 436 and a stent supplement 438 may extend the functionality of the blood vessel environment 420. The cholesterol buildup supplement 436 may include one or more three dimensional models configured to render a buildup of cholesterol in a blood vessel. The cholesterol buildup supplement 436 may also include instructions for simulating the gradual build up the cholesterol on the blood vessel wall, colliding with other matter such as blood clots, and receiving user input to toggle or otherwise control the described functionality. The stent supplement 438 may include one or more three dimensional models configured to render a surgical stent device. The stent supplement 438 may also include instructions for simulating a weakened blood vessel wall, simulating the stent supporting the blood vessel wall, and receiving user input to toggle or otherwise control the described functionality.

Some supplements may extend the functionality of other supplements. For example, the heart attack aspirin supplement 440 may extend the functionality of the myocardial infarction supplement 430 by, for example, providing instructions for receiving user input to administer aspirin and instructions for simulating the effect of aspirin on a heart attack. For example, in some embodiments, the instructions for simulating a heart attack carried by the myocardial infarction supplement 430 may utilize a value representing blood viscosity while the aspirin supplement may include instructions for reducing this blood viscosity value. As another example, the drug eluting stent supplement 442 may extend the functionality of the stent supplement by providing instructions for simulating drug delivery via a stent, as represented by the stent supplement 442. These instructions may simulate delivery of a specific drug or may illustrate drug delivery via drug eluting stent generally.

It will be apparent that the functionality described in connection with the environments and supplements of arrangement 400 are merely exemplary and that virtually any anatomical structure or biological event (e.g., natural functions, maladies, drug administration, device implant, or surgical procedures) may be implemented using a environment or supplement. Further, alternative or additional functionality may be implemented with respect to any of the exemplary environments or supplements described.

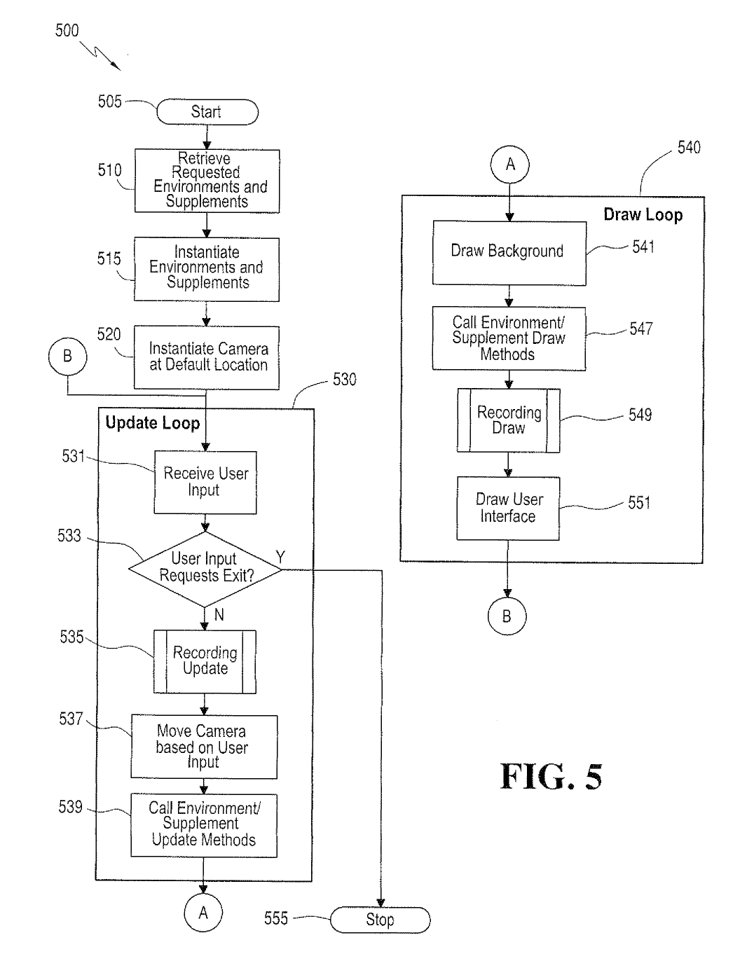

FIG. 5 illustrates an exemplary method 500 for recording user interaction with environments and supplements. Method 500 may be performed by the components of a device such as, for example, the simulator 122 and simulation recorder 124 of the authoring device 120 of system 100. Various other device for executing method 500 will be apparent such as, for example, the viewing device 130 in embodiments where the viewing device 130 includes a simulator 122 or simulation recorder 124.

The method 500 may begin in step 505 and proceed to step 510 where the device may retrieve any environments or supplements requested by a user. For example, where the user has requested the simulation of a heart attack, the system may retrieve a heart environment and myocardial infarction supplement for use. This retrieval may include retrieving one or more of the data objects from a local storage or cache or from a backend server that provides access to a library of environments or supplements. After retrieving the appropriate environments, the device may, in step 515, instantiate the retrieved environments or supplements. For example, the device may create an instance based on the class defining a myocardial infarction supplement and, in doing so, create an instance of the class defining a heart environment. Next, the device may instantiate one or more cameras at a default location and with other default parameters. As will be readily understood and explained in greater detail below, the term “camera” will be understood to refer to an object based on which images or video may be created. The camera may define a position in three-dimensional space, an orientation, a zoom level, and other parameters for use in rendering a scene based on a environment or supplement. In various embodiments, default camera parameters may be provided by a environment or supplement.

Next, the device may proceed to loop through the update loop 530 and draw loop 540 to simulate and render the anatomical structures or biological events. As will be understood, the update loop 530 may generally perform functions such as, for example, receiving user input, updating environments and supplements according to the user input, simulating various biological events, and any other functions that do not specifically involve rendering images or video for display. The draw loop, on the other hand, may perform functions specifically related to displaying images or video such as rendering environments and supplements, rendering user interface elements, and exporting video. In various embodiments, an underlying engine may determine when and how often the update loop 530 and draw loop 540 should be called. For example, the engine may call the update loop 530 more often than the draw loop 540. Further, the ratio between update and draw calls may be managed by the engine based on a current system load. In some embodiments, the update and draw loops may not be performed fully sequentially and, instead, may be executed, at least partially, as different threads on different processors or processor cores. Various additional modifications for implementing an update loop 530 and a draw loop 540 will be apparent.

The update loop 530 may begin with the device receiving user input in step 531. In various embodiments, step 531 may involve the device polling user interface peripherals such as a keyboard, mouse, touchscreen, or microphone for new input data. The device may store this input data for later use by the update loop 530. Next, in step 533, the device may determine whether the user input requests exiting the program. For example, the user input may include a user pressing the Escape key or clicking on an “Exit” user interface element. If the user input requests exit, the method 500 may proceed to end in step 555. Step 555 may also include an indication to an engine that the program should be stopped.

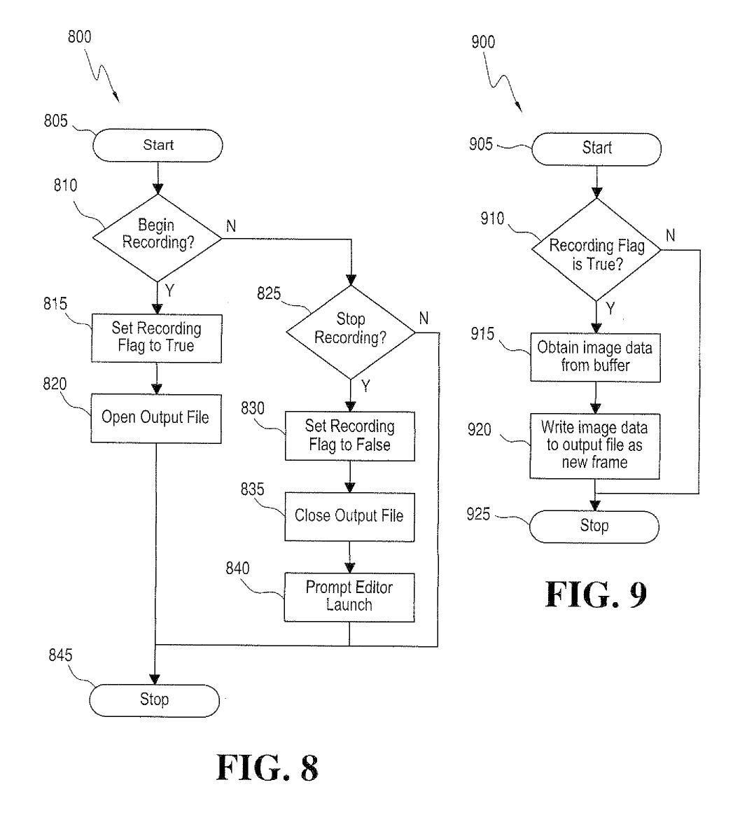

If, however, the user input does not request program exit, the method 500 may proceed to step 535 where the device may perform one or more update actions specifically associated with recording video. Exemplary actions for performance as part of step 535 will be described in greater detail below with respect to FIG. 8. Next, in step 537, the device may “move” the camera object based on user inputs. For example, if the user has pressed the “W” key or the “Up Arrow” key, the device may “move the camera forward” by updating a position parameter of the camera based on the current orientation. As another example, if the user has moved the mouse laterally while holding down the right mouse button, the device may “rotate” the camera by updating the orientation parameter of the camera. Various alternative or additional methods for modifying the camera based on user input will be apparent. Further, in some embodiments wherein multiple cameras are maintained, step 537 may involve moving such multiple cameras together based on the user input.

Next, in step 539, the device may invoke update methods of any top level environments or supplements. These update methods, defined by the environments or supplements themselves, may implement the simulation and interactivity functionality associated with those environments and supplements. For example, the update method of the heart environment may update the animation or expansion of the three dimensional heart environment in accordance with the heartbeat cycle. As another example, the myocardial infarction supplement may read user input to determine whether the user has requested that heart attack simulation begin. Various additional functions for implementation in the update methods of the environments and supplements will be apparent.

The update loop 530 may then end and the method 500 may proceed to the draw loop 540. The draw loop 540 may begin in step 541 where the device may “draw” the background to the graphics device. In various embodiments, drawing may involve transferring color, image, or video data to a graphics device for display. To draw a background, the device may set the entire display to display a particular color or may transfer a background image to a buffer of the graphics device. Next, iIn step 547, the device may call the respective draw methods of any top level environments or supplements. These respective draw methods may render the various anatomical structures and biological events represented by the respective environments and supplements. Further, the draw methods may make use of the camera, as most recently updated during the update loop 530. For example, the draw method of the heart environment may generate an image of the three dimensional heart model from the point of view of the camera and output the image to a buffer of a display device. It will be understood that, in this way, the user input requesting navigation may be translated into correspondingly updated imagery through operation of both the update loop 530 and draw loop 540.

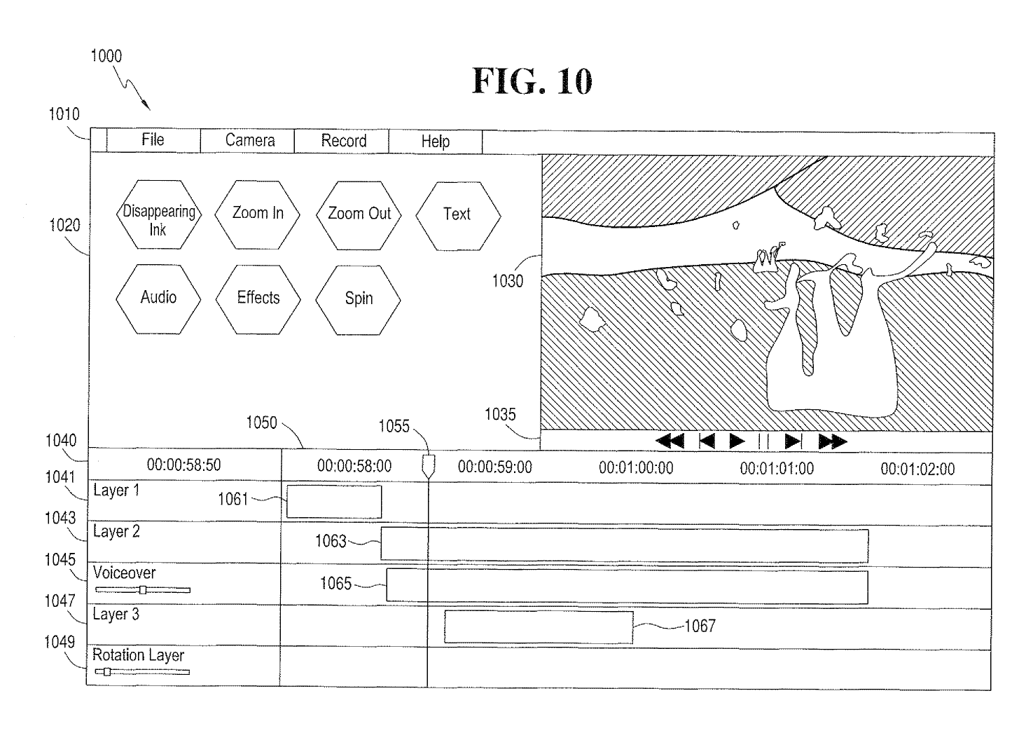

Next, in step 549, the device may perform one or more draw functions relating to recording a video file. Exemplary functions for drawing to a video file will be described in greater detail below with respect to FIG. 9. Then, in step 551, the device may draw any user interface elements to the screen. For example, the device may draw a record button, an exit button, or any other user interface elements to the screen. The method 500 may then loop back to the update loop 530.

It will be understood that various modifications to the draw loop are possible for effecting variations in the output images or video. For example, step 549 may be moved after step 551 so that the user interface is also captured. Various other modification will be apparent.

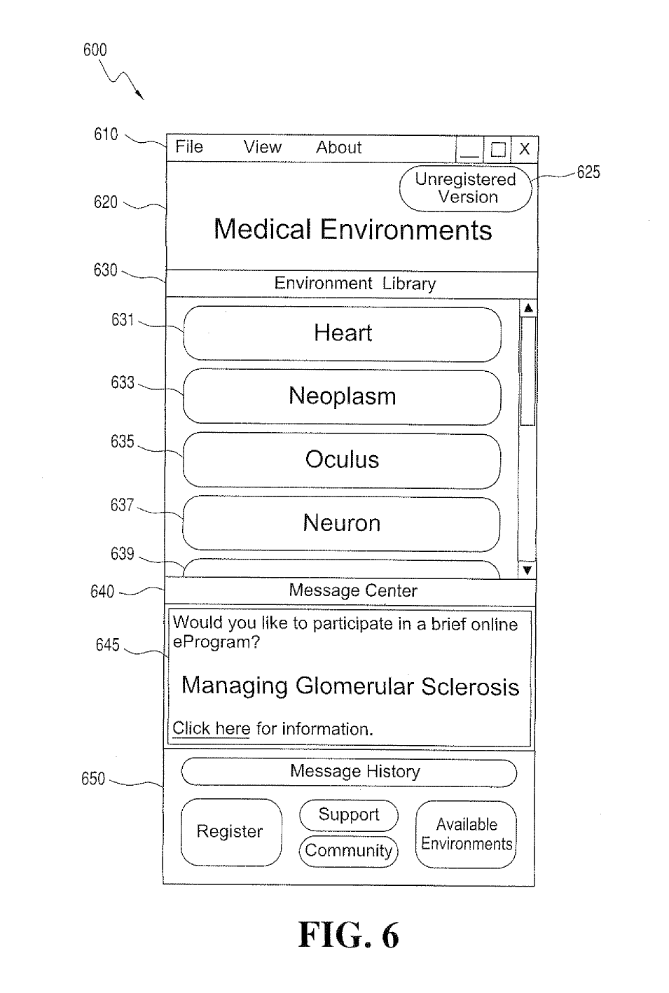

FIG. 6 illustrates an exemplary graphical user interface (GUI) 600 for providing access to a library of environments and supplements. In various embodiments, a user may utilize the GUI 600 to browse available environments and supplements and request that environments or supplements be loaded and simulated. The GUI 600 may include multiple elements such as a tool bar 610, title section 620, library section 630, message center 640, and control panel 650. The tool bar may include a series of menus for providing functionality such as exiting the program or viewing information about the program. Various other functionality to expose via the toolbar will be apparent.

The title section 620 may indicate the title of the program such as, for example, “Medical Environments.” The title section may also include an indication 625 as to whether the program is currently operating in registered or unregistered mode. In some embodiments, users may be able to access at least some environments or supplements whether or not the user is logged in or has paid for the software. For example, unregistered users may be provided with supplements illustrating sponsored products or services, such as a branded drug. In some embodiments, the indication 625 may be selectable and may direct the user to a login screen or registration form.

The environment library section 630 may provide a list of available environments for simulation. In some embodiments, the environment library section 630 may only list environments that have been downloaded and are locally available or may list environments that are available for download from a backend server library. As shown, the environment library section 630 may include buttons linking to various environments such as, for example, a heart environment button 631, a neoplasm environment button 633, an oculus button 635, a neuron button 637, and one or more additional buttons 639 accessible via a scroll bar. Each such button, upon selection, may indicate that a user wishes to commence simulation associated with the respective environment. For example, upon selecting the heart environment button 631, the GUI 610 may display one or more buttons, check boxes, or other elements suitable for selecting one or more supplements to be loaded with the heart environment. Then, after selection of zero or more supplements, the simulator may be invoked in accordance with the selected environment or supplements.

The message center 640 may be an area for displaying messages pushed to the user by another device, such as a backend server. Messages may be sent by other users and, as such, the message center may provide various social networking functionality. Further, messages may be sent by entities wishing to advertise services or products. Thus, the message center 640 may be used as a portal for permission based marketing. As shown, the message center 640 may display a message 645 advertising an eProgram along with a link. In some embodiments, the link may direct the user to a specific environment or supplement or video created by another user using the system.

The control panel section 650 may include various buttons or other GUI elements for managing the operation of the software. For example, the control panel section 650 may include buttons for registering the software, accessing a message history of the message center 640, requesting technical support, accessing a community area such as a forum, and browsing available environments that are not listed in the environment library section 630.

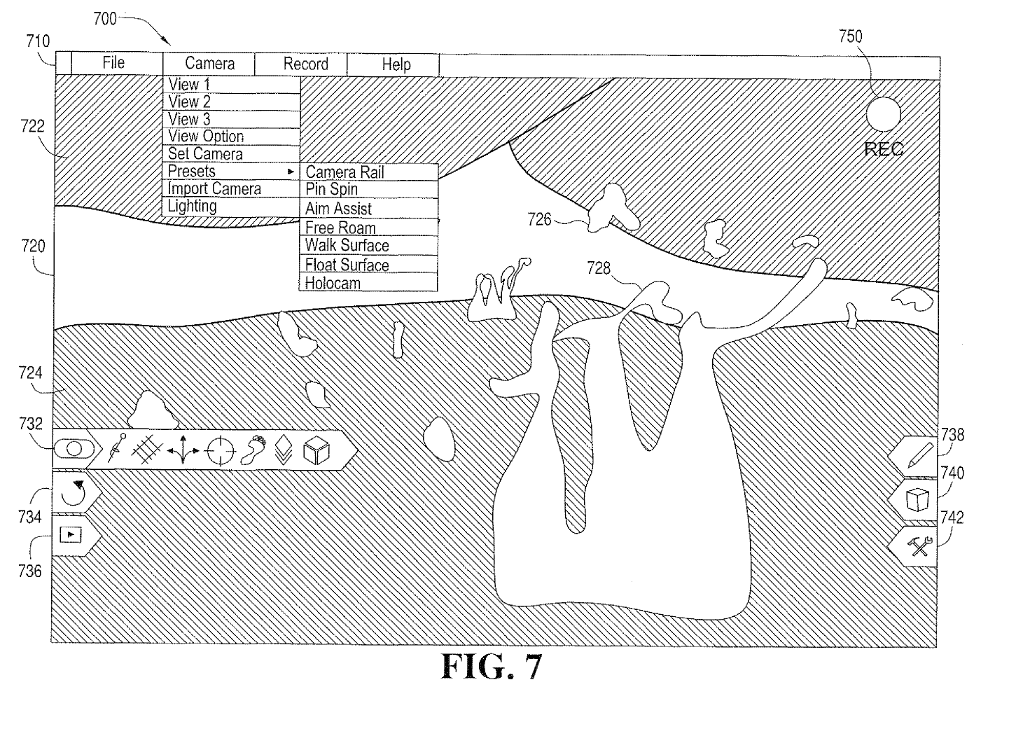

FIG. 7 illustrates an exemplary GUI 700 for recording interaction with environments and supplements. The GUI 700 may be used by the user to navigate an anatomical structure, trigger and observe a biological event, or record the user's experience. As shown, the GUI 700 may include a toolbar 710 and a viewing field 720. The toolbar may provide access to various functionality such as exiting the program, receiving help, activating a record feature, or modifying a camera to alter a scene. Various other functionality to expose via the toolbar 710 will be apparent.

The viewing field 720 may display the output of a draw loop such as the draw loop 540 of method 500. As such, the viewing field 720 may display various structures associated with a environment or supplement. The exemplary viewing field 720 of FIG. 7 may show a plurality of cell membranes 722, 724, one or more extracellular free-floating molecules 726, and one or more extracellular receptors 728. As the simulation progresses, the molecules 726 may, for example, float past the camera and bind with the receptors 728, thus simulating a biological event.

The viewing field 720 may include multiple GUI elements such as buttons 732, 734, 736, 738, 740, 742 for allowing the user to interact with the simulation. It will be apparent that other methods for allowing user interaction may be implemented. For example, touchscreen or mouse input near a molecule 726 may allow a user to drag the molecule 726 in space. The buttons 732-742 may enable various functionality such as modifying the camera, undoing a previous action, exporting a recorded video to the editor, annotating portions of the scene, deleting recorded video, or changing various settings. Further, various buttons may provide access to additional buttons or other GUI elements. For example, the button 732 providing access to camera manipulations may, upon selection, display a submenu that provides access to camera functionality such as a) “pin spin,” enabling the camera to revolve around a user-selected point, b) “camera rail,” enabling the camera to travel along a predefined path, c) “free roam,” allowing a user to control the camera in three dimensions, d) “aim assist,” enabling the camera's orientation to track a selected object as the camera moves, e) “walk surface,” enabling the user to navigate as if walking on the surface of a structure, f) “float surface,” enabling the user to navigate as if floating above the surface of a structure, or g) “holocam,” toggling holographic rendering.

The GUI 700 may also include a button or indication 750 showing whether video is currently being recorded. The button or indication 750 may also be selectable to toggle recording of video. In some embodiments, the user may be able to begin and start recording multiple times to generate multiple independent video clips for later use by the editor.

FIG. 8 illustrates an exemplary method 800 for toggling recording mode for environments and supplements. In various embodiments, the method 800 may correspond to the recording update step 535 of the method 500. The method 800 may be performed by the components of a device, such as the authoring device 120 of exemplary system 100.

The method 800 may begin in step 805 and proceed to step 810 where the device may determine whether the device should begin recording video. For example, the device may determine whether the user input includes an indication that the user wishes to record video such as, for example, a selection of the record indication 750 or another GUI element 710, 732-744 on GUI 700. In various embodiments, the input may request a toggle of recording status; in such embodiments, the step 810 may also determine whether the current state of the device is not recording by accessing a previously-set “recording flag.” If the device is to begin recording, the method 800 may proceed to step 815, where the device may set the recording flag to “true.” Then, in step 820, the device may open an output file to receive the video data. Step 820 may include establishing a new output file or opening a previously-established output file and setting the write pointer to an empty spot and or layer for receiving the video data without overwriting previously-recorded data. The method 800 may then end in step 845 and the device may resume method 500.

If, on the other hand, the device determines in step 810 that it should not begin recording, the method 800 may proceed to step 825 where the device may determine whether it should cease recording video. For example, the device may determine whether the user input includes an indication that the user wishes to stop recording video such as, for example, a selection of the record indication 750 or another GUI element 710, 732-744 on GUI 700. In various embodiments, the input may request a toggle of recording status; in such embodiments, the step 825 may also determine whether the current state of the device is recording by accessing the recording flag. If the device is to stop recording, then the method 800 may proceed to step 830 where the device may set the recording flag to “false.” Then, in step 835, the device may close the output file by releasing any pointers to the previously-opened file. In some embodiments, the device may not perform step 835 and, instead, may keep the file open for later resumption of recording to avoid unnecessary duplication of steps 820 and 835. After stopping recording in steps 830, 835, the device may prompt the user in step 840 to open the video editor to further refine the captured video file. For example, the device may display a dialog box with a button that, upon selection, may close the simulator or recorder and launch the editor. The method 800 may then proceed to end in step 845. If, in step 825, the device determines that the device is not to stop recording, the method 800 may proceed directly to end in step 845, thereby effecting no change to the recording status.

FIG. 9 illustrates an exemplary method 900 for outputting image data to a video file. In various embodiments, the method 900 may correspond to the recording draw step 549 of the method 500. The method 900 may be performed by the components of a device, such as the authoring device 120 of exemplary system 100.

The method 900 may begin in step 905 and proceed to step 910 where the device may determine whether video data should be recorded by determining whether the recording flag is currently set to “true.” If the recording flag is not “true,” then the method may proceed to end in step 925, whereupon method 500 may resume execution. Otherwise, the method 900 may proceed to step 915, where the device may obtain image data currently stored in an image buffer. As such, the device may capture the display device output, as currently rendered at the current progress through the draw loop 540. Various alternative methods for capturing image data will be apparent. Next, in step 920, the device may write the image data to the currently-open output file. Writing the image data may entail writing the image data at a current write position of a current layer of the output file and then advancing the write pointer to the next empty location or frame of the output file. In some embodiments, the device may also capture audio data from a microphone of the device and output the audio data to the output file as well.

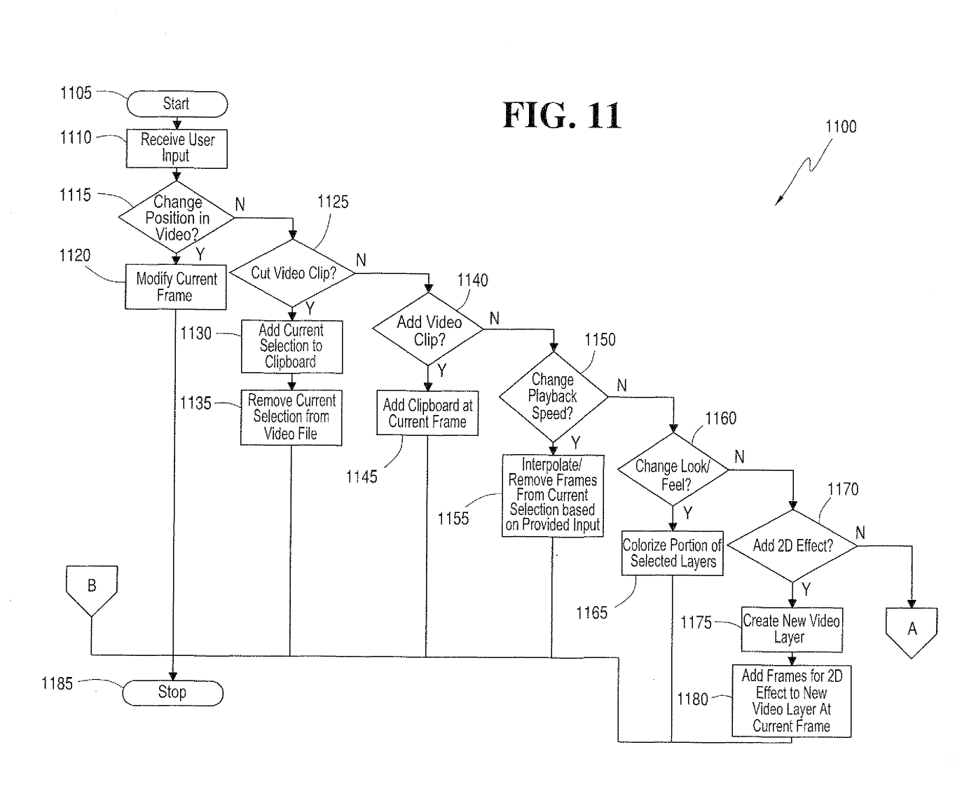

FIG. 10 illustrates an exemplary GUI 1000 for editing a video file. The GUI 1000 may be displayed when a simulation editor is running on a device such as, for example, the authoring device 120 of the exemplary system 100. As shown, the GUI 1000 may include a toolbar 1010, a toolbox 1020, a video preview 1030, a layer and timeline section 1040. The toolbar 1010 may provide access to various functionality such as exiting the program, receiving help, or returning to a simulator or recorder program or feature. Various other functionality to expose via the toolbar 1010 will be apparent.

The toolbox 1020 may provide access to multiple video editing tools. As shown, the toolbox 1020 may include multiple icons that, upon selection, may provide access to an associated tool. For example, the toolbox 1020 may provide access to an audio tool for recording audio narration, zoom tools for modifying a current zoom level of captured video, or text tools for superimposing text over the captured video. Various additional tools and associated functionality for editing and enhancing a video will be apparent.

The video preview 1030 may include a video player that enables playback of recorded video. As such, the video preview 1030 may include playback controls 1035 for playing, pausing, skipping, and shuttling through the captured video. Various other functionality such as, for example, volume controls, zooming, and fullscreen toggling may be provided by the video preview 1030 as well.

The layers and timeline section 1040 may provide the user with the ability to perform functions such as selecting specific layers, shuttling through the video, and rearranging playback data such as clips and effects. As shown, the layers and timeline section 1040 may include an indication of a current time in the video (e.g., “00:00:58:50”) along with a listing of layers 1041, 1043, 1045, 1047, 1049 that compose the video file. As will be understood, the video file may include multiple layers, or streams, of content, one or more of which may be played back at a single time. For example, as shown, the video file may include three video layers, one audio layer, and one effect layer. In some embodiments, multiple video layers may be created by the user toggling the record feature of the simulator multiple times before proceeding to the video editor. Additional layers may be created by the user via the editor by, for example, selecting tools from the toolbox 1020 that add new layers to the video file.

The layers and timeline section 1040 may also include a timeline 1050 and current time pointer 1055. These elements may enable the user to both identify a current time and layer date used to render the current image in the video preview 1030 and to shuttle through the video by dragging the time pointer 1055.

Next to the various layers 1041-1049, the layers and timeline section 1040 may include indications of data 1061, 1063, 1065, 1067 carried by the video file at various times as matched to the timeline 1050. As shown, the time pointer 1055 may include a downwardly extending line to illustrate which layers contain data that are used in rendering the current frame. As such, the layers and timeline section 1040 facilitates the user in determining which layers may be used in rendering the current portion of the video. As shown, the data blocks 1063, 1065 of the “Layer 2” 1043 and “Voicover” 1045 layers may be used in determining the current frame of the video output in the video display 1030, while the remaining data blocks 1061, 1067 may not currently be displayed.

Various additional functionality for the video editor via the GUI 1000 will be apparent. For example, the user may be able to rename, rearrange, delete, mute, change volume, or change other parameters of the layers 1041-1049. Further, the user may be able to set some layers 1041-1049 to be invisible or inaudible. In some such embodiments, the user may configure such invisible or inaudible layers to become visible or audible during playback after the occurrence of some trigger, such as the video reaching a certain point or by the user selecting a widget or other GUI element.

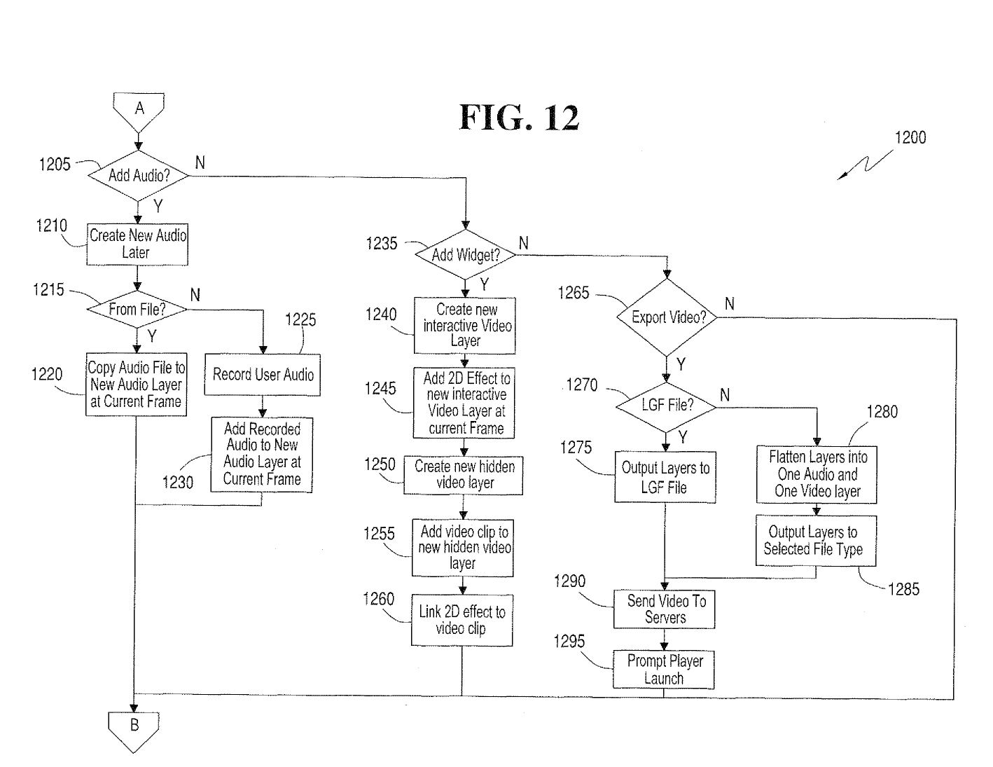

FIG. 11 and FIG. 12 illustrate an exemplary method 1100, 1200 for editing a video file. The method 1100, 1200 may be performed by the components of a device providing a simulation editor such as, for example, the authoring device 120 or viewing device 130 of the exemplary system 100. It will be apparent that the method 1100, 1200 may be a simplification in some respects and may implemented differently that described. For example, the method 1100, 1200 may be implemented as part of an update loop invoked by an engine supporting the video editor. Further, rather than testing for input invoking each available tool, the tools may be invoked via an event listener that, upon selection of an appropriate GUI element, calls the associated functions. Various other modifications will be apparent.

The method 1100, 1200 may begin in step 1105 and proceed to step 1110 where the device may receive user input 1110 such as, for example, mouse, keyboard, touchscreen, or audio input. Next, the device may begin deciphering the input by first, in step 1115, determining whether the input requests a change to a current video position. For example, the input may include a selection of skip or shuttle elements of the playback controls 1035 or a change to the position of the time pointer 1055 of the GUI 1010. If so, the device may modify the current frame accordingly in step 1120 such that, on the next draw loop, the video will be drawn near the new current frame.

In step 1125, the device may determine whether the user input requests that a particular clip or portion thereof be cut. For example, the device may determine that video data such as data blocks 1061, 1063, 1067 or portions thereof is currently selected and that the user has pressed the “control” and “X” keys on their keyboard. If so, the device may, in step 1130, add the selected data to a clipboard and then, in step 1135, remove the data from the video file.

In step 1140, the device may determine whether the user input requests that a clip be added to the video. For example, the device may determine that a user has pressed the “control” and “V” keys on their keyboard. If so, the device may, in step 1145, insert any data currently carried by the clipboard into the video or currently selected layer at the current frame.

In step 1150, the device may determine whether the user input requests that the playback speed of the video or a clip be altered. For example, the device may determine that a user has activated a “speed up” or “slow down” tool from the toolbox 1020. If so, the device may, in step 1155, effect the playback speed change. For example, if the video has been sped up, the device may remove multiple frames at some interval from the currently selected data. As another example, if the video has been slowed down, the device may insert frames at some interval to the currently selected data, creating the new frames by interpolating the frames currently located on either side of the insertion point. Various other methods for changing playback speed will be apparent.

In step 1160, the device may determine whether the user input requests that the “look and feel” of a clip be changed. For example, the device may determine that a user has selected a “change background” or “colorize” tool from the toolbox 1020. If so, the device may, in step 1165, effect the change to the selected video portion by changing the background image, colorizing portions of the selected layer, or changing other data associated with the “look and feel” of the video.

In step 1170, the device may determine whether the user input requests that a 2D effect added to the video. For example, the device may determine that a user has selected a “text” or “effects” tool from the toolbox 1020. If so, the device may, in step 1175, create a new video layer to hold the effect data and then, in step 1180, add one or more frames to the new layer starting at the current frame to add the requested effect. It will be understood that the new frames may include transparency data such that the new video data is overlaid with respect to the already-existing video data.

In step 1205, the device may determine whether the user input requests that audio be added to the video. For example, the device may determine that a user has selected an “audio” tool from the toolbox 1020. If so, the device may, in step 1210 create a new audio layer to hold the new audio data. Next, in step 1215, the device may determine whether the audio data will come from a file or from direct user input via a microphone. If the audio data is to be imported from a separate file, the device may, in step 1220, copy the audio data from the file to the new audio layer starting at the current frame. Otherwise, the device may, in step 1225, record the user audio via the microphone and, in step 1230, transfer the recorded audio to the new audio layer starting at the current frame.

In step 1235, the device may determine whether the user input requests that a widget be added to the video. For example, the device may determine that a user has selected a “widget” tool from the toolbox 1020. If so, the device may, in step 1140, create a new interactive video layer in step 1240 to hold the widget data. Then, in step 1245, the device may add new 2D effect data to the new interactive video layer to represent the widget. The interactive video layer may also store target data, such as a bounding box for the 2D effect, such that user selection of the 2D effect may be detected. Next, in step 1250, the device may create a new video layer initially set to be invisible and, in step 1255, add new video data to the new video layer. To be displayed upon widget selection. Finally, in step 1260, the device may link the 2D effect to the new video clip. Various alternative methods for embedding video will be apparent. For example, the linked video may be added to an existing layer but at a location that is not already occupied by data and that is not normally accessible by a video player. Various modifications for playback of such an embodiment will be apparent.

In step 1265, the device may determine whether the user input requests that the video be exported for playback. For example, the device may determine that a user has selected an “export” tool from the toolbox 1020. If so, the device may, in step 1270 determine whether the video is to be exported as a proprietary or otherwise layered video format (e.g., an “LGF” format). This determination may be made based on a user selection of the desired output format. If so, the device may, in step 1275, output each layer separately to a new layer of the output video. Otherwise, in step 1280, the device may flatten the layers into a single video layer and a single audio layer. This step may include removing or rendering inactive any interactive layers or linked layers associated therewith. Then, the device may, in step 1285, output the two layers to a new file of the selected type. For example, the device may create an MPEG, WMV, AVI, or OGG file.

After creating the requests output file, the device may, in step 1290, send the new video to one or more servers such as, for example, the backend server 110 of the exemplary system 100. Step 1290 may also include making the video available to other users and tagging the video with metadata such as, for example, title and author. The device may also prompt, in step 1295, the user to launch player software to view the exported video. The method 1100, 1200 may then proceed to end in step 1185.

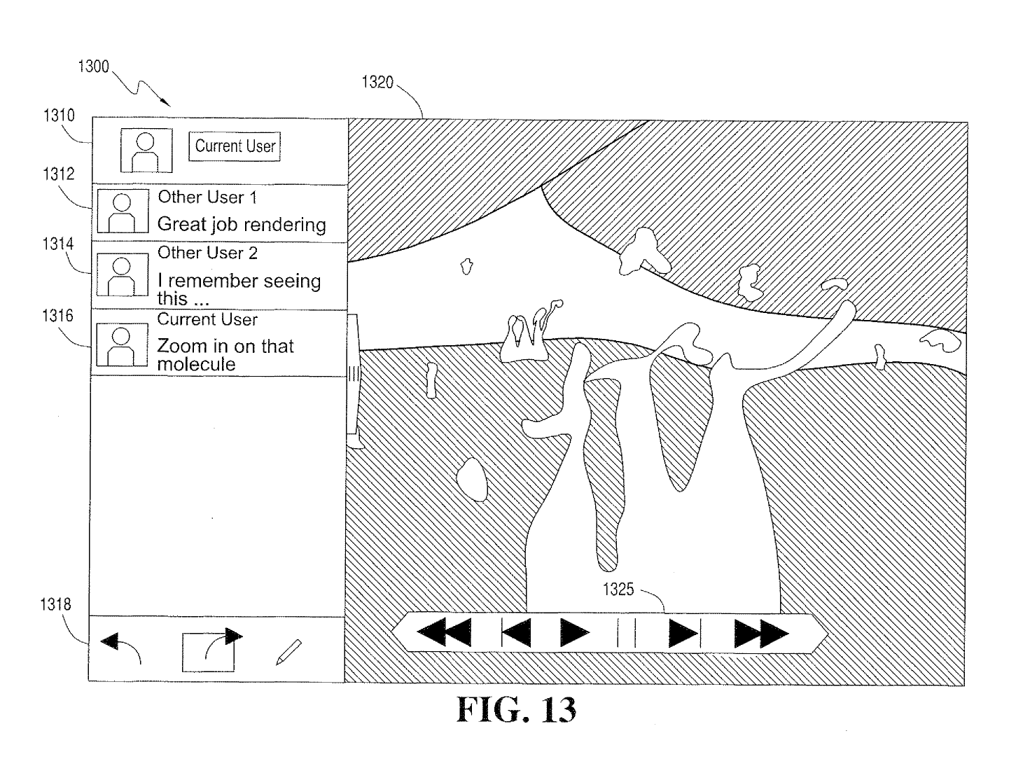

FIG. 13 illustrates an exemplary GUI 1300 for playing back a video file. The GUI 1300 may be displayed when a simulation viewer is running on a device such as, for example, the authoring device 120 of the exemplary system 100. As shown, the GUI 1300 may include a social and control pane 1310 and a viewing pane 1320.

The social and control pane 1310 may include an indication 1310 of a current user account that is logged in and viewing a video. For example, the indication 1310 may include a profile picture and name of the current user of the device displaying the GUI 1300. The social and control pane 1310 may also include one or more messages associated with the currently displayed video. As shown, the social and control pane 1310 may display two messages 1312, 1314 posted by other users as well as a message 1316 posted by the current user. The current user may also use the social and control pane 1310 to post additional messages for association with the current video. In this manner, the social and control pane 1310 enables users to discuss a video. The social and control pane 1310 may also include controls 1318 for interacting with the simulation viewer. For example, the controls 1318 may include selectable GUI elements to exit the current video to return to a previous view such as a listing of available videos or a social media page that linked to the presently displayed video, to share the video with other users of the system, or to further edit the video and thereby return to the video editor GUI 1000 or a limited version thereof. The social and control pane 1310 may also include a handle to minimize the social and control pane 1310, thereby providing a fuller view of the viewing pane 1320.

The viewing pane 1320 may playback a previously-created video. As such, the viewing pane 1320 may include playback controls 1325 to enable a user to play, pause, skip, and shuttle through the video. The viewing pane 1320 may also display, based on the video file being played, selectable widgets that, upon selection, modify playback of the video by, for example, displaying a previously-hidden video clip.

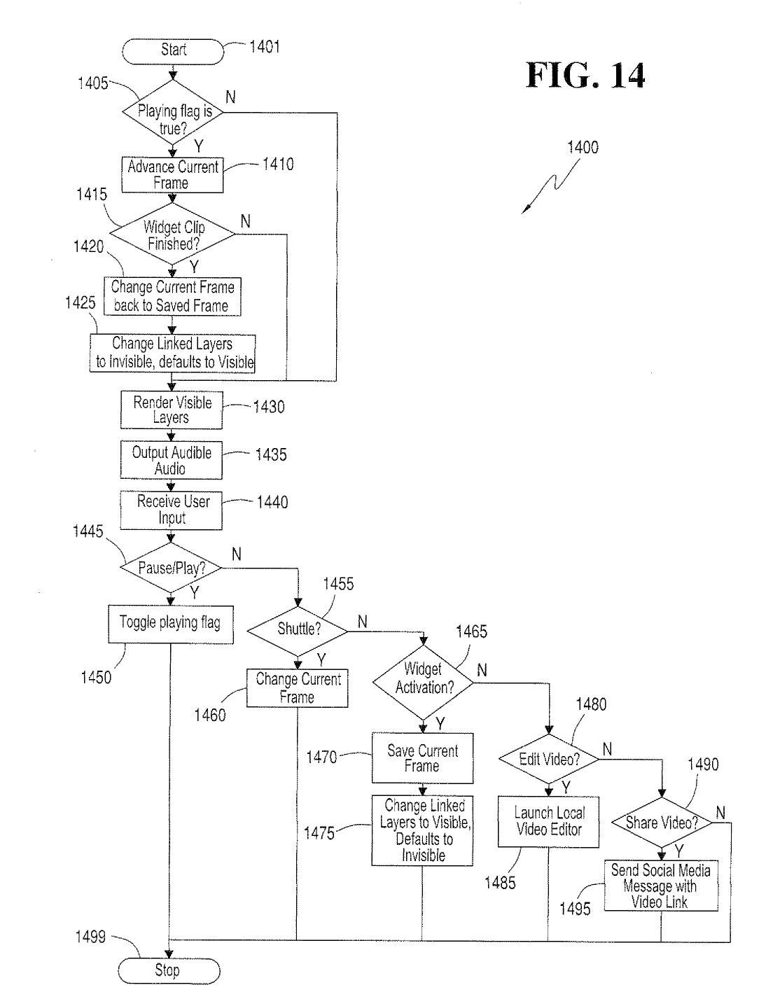

FIG. 14 illustrates an exemplary method 1400 for playing back a video file. The method 1400 may be performed by the components of a device providing a simulation viewer such as, for example, the authoring device 120 or viewing device 130 of the exemplary system 100. It will be apparent that the method 1400 may be a simplification in some respects and may implemented differently that described. For example, the steps of method 1400 may be split, as appropriate, between an update and draw loop invoked by an engine supporting the video editor. Further, rather than testing for input invoking each available tool, the tools may be invoked via an event listener that, upon selection of an appropriate GUI element, calls the associated functions. Various other modifications will be apparent.

Method 1400 may begin in step 1401 and proceed to step 1405 where the device may determine whether a “playing” flag is currently set to true, indicating whether the video is currently playing or paused. If the playing flag is “false,” the method 1400 may skip ahead to step 1430. Otherwise, the device may, in step 1410, advance the current frame. For example, the device may increment the current frame by one or increase the current frame by multiple frames based on an indication of how much time has elapsed since the last execution of method 1400. Next, in step 1415, the device may determine whether a previously-activated widget clip has finished playing. If a widget clip is still playing or if no widget is currently activated, the method 1400 may skip ahead to step 1430. Otherwise, the device may return to the point in the video where the widget was activated by first, in step 1420, changing a current frame of the video back to a previously-saved frame from when the widget was first activated. Then, in step 1425, the device may change the linked layers to invisible and the default layers to visible, thereby reverting the video to its state prior to widget selection. It will be apparent that, when the current video does not support selectable widgets, steps 1415-1425 and 1465-1475 may not be performed or present.

In step 1430, the device may render any layers currently set to visible at the current frame location. As such, the device may build, from one or more layers of video data, a single image to be output. In embodiments wherein the current video file only includes a single video layer, the data from the single video layer may be output as stored. Next, in step 1435, the device may output audio from any audible audio layers at the current frame location. In embodiments wherein the current video file only includes a single audio layer, the data from the single audio layer may be output as stored.

The device may then begin to process user input by, in step 1440, receiving user input to process such as, for example, mouse, keyboard, touchscreen, or audio input. In step 1445, the device may determine whether the user input requests that the video be set to pause or play. For example, the device may determine that a user has selected a “pause” or “play” icon of the playback controls 1325. If so, the device may, in step 1450, toggle the playing flag. As such, on the next execution of the method 1400, the video may either begin or stop advancing the current frame, as appropriate.

In step 1455, the device may determine whether the user input requests that the video be skipped or shuttled. For example, the device may determine that a user has selected a “skip” or “shuttle” icon of the playback controls 1325. If so, the device may, in step 1460, change the current frame location based on the input. For example, if the user has requested video skip, the current frame location may be incremented by a predetermined number and, if the user has requested a video shuttle, the current frame location may be incremented by a smaller predetermined number.

In step 1465, the device may determine whether the user input activates a widget. For example, the device may determine that a user has clicked within a target area for a 2D effect of an interactive video layer. If so, the device may, in step 1470, save the current frame for later use when the widget clip finishes playing. Then, in step 1475, the device may begin playing the widget clip by setting all currently-visible layers to invisible and setting any linked layers, as identified by the interactive video layer, to visible.

In step 1480, the device may determine whether the user input requests that the video editor be launched. For example, the device may determine that a user has selected an “edit” icon from the controls 1318. If so, the device may, in step 1485, launch a local version of the video editor and load the current video to be edited. In various embodiments, the video editor may be an abridged version of the video editor used by the authoring device 120. For example, where the device executing the method 1400 is a tablet, the editor may include an alternative editor GUI from GUI 1000 and may provide only a subset of the tools provided by the GUI 1000.

In step 1490, the device may determine whether the user input requests that the video be shared with other users. For example, the device may determine that a user has selected a “share” icon of the controls 1318. If so, the device may, in step 1495, transmit a social media message including a link to the present video to one or more other users. Such message may be delivered directly to specified users or may be publicly displayed in association with the current user such that any other user visiting a page associated with the current user may view the message and video link. The method 1400 may then proceed to end in step 1499.

It will be understood that the various systems and methods described herein may be applicable to fields outside of medicine. For example, the systems and methods described herein may be adapted to other models such as, for example, mechanical, automotive, aerospace, traffic, civil, or astronomical systems. Further, various systems and methods may be applicable to fields outside of demonstrative environments such as, for example, video gaming, technical support, or creative projects. Various other applications will be apparent.

It should be apparent from the foregoing description that various exemplary embodiments of the invention may be implemented in hardware or software running on a processor. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media. Further, as used herein, the term “processor” will be understood to encompass a microprocessor, field programmable gate array (FPGA), application-specific integrated circuit (ASIC), or any other device capable of performing the functions described herein.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be effected while remaining within the spirit and scope of the invention. Accordingly, the foregoing disclosure, description, and figures are for illustrative purposes only and do not in any way limit the invention, which is defined only by the claims.

What is claimed is:

1. A method performed by an authoring device for creating a digital medical presentation, the method comprising:
displaying, on a display of the authoring device, a first representation of a environment, wherein the environment represents an anatomical structure;
receiving, via a user input interface of the authoring device, a user input representing a requested change to the first representation of the environment;
displaying, on the display, a transition between the first representation of the environment and a second representation, wherein the second representation is created based on the requested change; and
generating a video file, wherein the video file enables playback of the transition.

2. The method of claim 1, wherein:
the first representation and the second representation are created from the point of view of a camera having at least one of a position, a zoom, and an orientation, and
the requested change comprises a request to alter at least one of the position, the zoom, and the orientation of the camera.

3. The method of claim 1, wherein:
the requested change comprises a request to trigger a biological event associated with the anatomical structure, and
the transition includes a plurality of image frames that simulate the biological event with respect to the environment.

4. The method of claim 1, wherein:
the requested change comprises a request to view another anatomical structure, and
the second representation is created based on a another environment that represents the other anatomical structure.

5. The method of claim 1, further comprising:
receiving a user input representing a requested edit from a user; and
modifying the video file based on the requested edit.

6. The method of claim 5, wherein:
the requested edit comprises a request to add audio data to the video file, and
modifying the video file comprises adding the audio data to an audio track of the video file, whereby the video file enables playback of the audio data contemporaneously with the transition.

7. The method of claim 5, wherein:
the requested edit comprises a request to add an activatable element to the video file, and
modifying the video file comprises:
adding a graphic to a first portion of the video file, and
associating the graphic with a second portion of the video file, whereby a user selection of the graphic during playback of the first portion of the video file initiates playback of the second portion of the video file.

8. The method of claim 1, further comprising publishing the video file for playback on at least one viewing device other than the authoring device.

9. A non-transitory machine-readable storage medium encoded with instructions for execution by an authoring device for creating a digital medical presentation, the medium comprising:
instructions for displaying, on a display of the authoring device, a first representation of a environment, wherein the environment represents an anatomical structure;
instructions for receiving, via a user input interface of the authoring device, a user input representing a requested change to the first representation of the environment;
instructions for displaying, on the display, a transition between the first representation of the environment and a second representation, wherein the second representation is created based on the requested change; and
instructions for generating a video file, wherein the video file enables playback of the transition.

10. The non-transitory machine-readable storage medium of claim 9, wherein:
the first representation and the second representation are created from the point of view of a camera having at least one of a position, a zoom, and an orientation, and
the requested change comprises a request to alter at least one of the position, the zoom, and the orientation of the camera.

11. The non-transitory machine-readable storage medium of claim 9, wherein:
the requested change comprises a request to trigger a biological event associated with the anatomical structure, and
the transition includes a plurality of image frames that simulate the biological event with respect to the environment.

12. The non-transitory machine-readable storage medium of claim 9, wherein:
the requested change comprises a request to view another anatomical structure, and
the second representation is created based on a another environment that represents the other anatomical structure.

13. The non-transitory machine-readable storage medium of claim 9, further comprising:
instructions for receiving a user input representing a requested edit from a user; and
instructions for modifying the video file based on the requested edit.

14. The non-transitory machine-readable storage medium of claim 13, wherein:
the requested edit comprises a request to add audio data to the video file, and
the instructions for modifying the video file comprise instructions for adding the audio data to an audio track of the video file, whereby the video file enables playback of the audio data contemporaneously with the transition.

15. The non-transitory machine-readable storage medium of claim 13, wherein:
the requested edit comprises a request to add an activatable element to the video file, and
the instructions for modifying the video file comprise:
instructions for adding a graphic to a first portion of the video file, and
instructions for associating the graphic with a second portion of the video file,
whereby a user selection of the graphic during playback of the first portion of the video file initiates playback of the second portion of the video file.

16. The non-transitory machine-readable storage medium of claim 9, further comprising instructions for publishing the video file for playback on at least one viewing device other than the authoring device.

17. A non-transitory machine-readable storage medium encoded with instructions for execution by an authoring device for creating a digital medical presentation, the medium comprising:
instructions for simulating an anatomical structure and a biological event associated with the anatomical structure, wherein the biological event comprises at least one of a biological function, a malady, a drug administration, a surgical device implantation, and a surgical procedure;
instructions for enabling user interaction via a user interface device to alter the simulation of the anatomical structure and the biological event;
instructions for displaying a graphical representation of the anatomical structure and the biological event via a display device to a user, wherein display of the graphical representation based on the simulation and user interaction creates a user experience; and
instructions for creating a video file, wherein the video file enables playback of the user experience.

18. The non-transitory machine-readable storage medium of claim 17, wherein the user interaction changes at least one of a position and an angle of a camera from which the simulation is generated.

19. The non-transitory machine-readable storage medium of claim 17, further comprising instructions for enabling a user to edit the video file.

20. The non-transitory machine-readable storage medium of claim 19, wherein the instructions for enabling a user to edit the video file comprise instructions for enabling a user to add a selectable element to the video file wherein the selectable element enables playback of a previously hidden video stream of the video file.
